(19) United States
(12) Patent Application Publication
(10) Pub. No.: US 2018/0329015 A1
(43) Pub. Date: Nov. 15, 2018

(54) SYSTEM FOR LOCATING AN OBJECT FURNISHED WITH AN RFID TAG

(71) Applicant: TAGSYS, LA CIOTAT (FR)

(72) Inventors: Christophe LOUSSERT, AIX-EN-PROVENCE (FR); Michel TALON, MIRAMAS (FR); Alexey PODKOVSKIY, LE MANS (FR)

(21) Appl. No.: 15/521,530

(22) PCT Filed: Oct. 23, 2015
(86) PCT No.: PCT/FR2015/052866

§ 371 Date: Sep. 21, 2017

(30) Foreign Application Priority Data
Oct. 23, 2014 (FR) 1460214

(51) Int. Cl. G01S 1/82; G01S 13/75; G01S 5/18

(52) U.S. Cl. CPC G01S 1/82; G01S 5/183; G01S 13/756

(57) ABSTRACT

Some embodiments are directed to a system for locating an object furnished with a tag in a predetermined space. The tag is interrogatable remotely by an RFID reader. According to the invention, a zone of sound is created with an ultrasound generator. A sound wave of frequency f1−f2 is present in this zone. The tag is equipped with an acoustic sensor able to sense the signals of frequency f1-f2 and this acoustic sensor is designed together with the tag to modify the content or the level of the RFID tag response signal when the acoustic sensor receives a signal of frequency f1-f2. The RFID reader is then able to locate the object in the zone of sound when it receives the modified response signal from the RFID tag or when it no longer receives any response signal from the RFID tag.

### CROSS REFERENCE TO RELATED APPLICATION(S)

This application is a national phase filing under 35 C.F.R. § 371 of and claims priority to PCT Patent Application No. PCT/FR2015/052866, filed on Oct. 23, 2015, which claims the priority benefit under 35 U.S.C. § 119 of French Patent Application No. 1460214, filed on Oct. 23, 2015, the contents of each of which are hereby incorporated in their entireties by reference.

### BACKGROUND

Some embodiments are directed to the field of locating objects equipped with RFID tags. In particular, some embodiments can be used to locate objects in a warehouse or a hangar.

RFID or Radio Frequency Identification technology is very commonly used today to classify, identify or track all types of objects. The infrastructure required to install this technology generally includes a plurality of RFID tags arranged on the objects to be tracked and one or more RFID readers distributed throughout the reading zone to be covered in order to interrogate the tags. The RFID reader emits an interrogation signal and the tags receiving the interrogation signal respond by sending a response signal.

There are different types of tags: passive (no internal power source), active (powered by an internal power source), and semi-passive (battery-assisted). With a passive tag, the tag retro-modulates the interrogation signal to transmit information. A passive tag generally uses the wave (magnetic or electromagnetic wave) of the interrogation signal to power its embedded electronic circuit. With an active tag, the tag includes an RF emitter and the communication with the interrogator is therefore of the peer-to-peer type. This type of tag allows for the receipt of weaker interrogation signals than passive tags, and for responses to be issued thereto. It can also have additional functions, through a memory, a sensor or a cryptographic module. A semi-passive tag is a hybrid tag. It communicates with the reader as a passive tag, however it includes an internal battery that constantly powers its internal circuit.

This technology is used not only to identify and classify, via their tags, objects present on a given site (warehouse, hangar, etc.), but also to locate them on this site.

### SUMMARY

Different methods have been developed for locating RFID tags from their response signals. These methods generally use a triangulation approach and estimate the position of a tag based on 3 known reference points. These methods are based on the measurement of parameters such as the Time of Arrival or TOA, the Difference Time of Arrival or DTOA, the Received Signal Strength or RSS, or the Received Signal Phase or RSP.

These methods have the following disadvantages:

the need for at least three RFID readers, each emitting a specific interrogation signal to locate the tag;

the tag being located must also be able to receive the interrogation signals from these three RFID readers, and to return them with sufficient strength so that they are received by the three RFID readers; this means that the system must include a dense network of RFID readers;

moreover, if the tags are passive, their remote powering requires the use of a strong signal emission, resulting in multiple reflections, above all in a closed environment; the multiple electromagnetic wave paths are simultaneously received by a plurality or by all RFID readers, considerably reducing the accuracy for locating the tags.

Some embodiments address or overcome all or part of the aforementioned disadvantages.

According to some embodiments, RFID technology is coupled with sound and ultrasonic wave technology to locate an RFID tag. It is reminded that the ultrasonic waves propagate at frequencies exceeding 20 kHz, and that the audible sound frequencies are located within the 20 Hz-20 kHz band. According to some embodiments, the use of the sound (or acoustic) wave derived from the difference between two ultrasonic waves is proposed in order to located an RFID tag. This sound wave is traditionally called a parametric wave. Its main feature is that it has a directivity level of its radiation pattern that is much higher than that of a classic sound wave or UHF electromagnetic wave used in RFID. According to some embodiments, this directivity is used to locate the tags.

Some embodiments are directed to a system for locating at least one object in a predetermined space, the system including at least one RFID tag positioned in or on an object to be located in the predetermined space, and an RFID reader capable of emitting at least one radiofrequency interrogation signal to the RFID tag and of receiving a radiofrequency response signal from the RFID tag. According to some embodiments, the system further includes at least one ultrasound generator capable of emitting in a given direction ultrasound signals of frequencies f1 and f2 in the predetermined space, where f1>f2, so as to generate a parametric signal of frequency f1−f2 in a specific zone, called a zone of sound, of the predetermined space, the frequencies f1 and f2 being greater than 20 kHz and the frequency difference f1−f2 being less than 20 kHz. Moreover, the tag is equipped with an acoustic sensor able to capture the signals of frequency f1−f2, the acoustic sensor being designed together with the RFID tag to modify the content or the level of the RFID tag response signal when the acoustic sensor receives a signal of frequency f1−f2. The RFID reader is thus able to locate the object in the zone of sound when it receives the modified response signal from the RFID tag.

According to some embodiments, the directivity of the parametric wave derived from the ultrasound signals of frequencies f1 and f2 is used to create a zone of sound in the predetermined space. The parametric wave of frequency f1−f2 is only present in this zone of the predetermined space. The receipt of this parametric wave by the acoustic sensor of a tag means that this tag is present in this zone.

According to some embodiments, the receipt of this parametric wave results in a modification to the response of the RFID tag. This modification can consist in reducing the strength of the response signal. Therefore, the response signal may not be received by the RFID reader. This modification can further consist in modifying the content of the response signal, by modifying, for example, a bit in the response signal.

According to a first embodiment, the strength of the response signal is reduced when the acoustic sensor receives a sound signal of frequency f1−f2. In this embodiment, the RFID tag is a passive tag including an RFID chip coupled to a magnetic antenna. The acoustic sensor is a capacitive sensor coupled to the magnetic antenna of the tag so as to modify the resonant frequency of the magnetic antenna when the acoustic sensor receives a signal of frequency f1−f2. The magnetic antenna of the tag is therefore detuned for receiving the interrogation signal and emitting the response signal. The response signal retro-modulated by the tag is therefore reduced in strength. If the strength of the response signal retro-modulated by the tag is significantly reduced, it may be such that it falls below the receipt threshold of the RFID reader. The RFID reader no longer receives the response signal from the tag and acts as if it has received a modified response signal. The tag is thus located in the zone of sound.

According to another embodiment, the RFID tag is an active or semi-passive tag including an RFID chip coupled to a magnetic antenna, the acoustic sensor is a piezoelectric sensor powered by the RFID tag and the RFID tag is further equipped with a microcontroller powered by the RFID tag and capable of writing in a registry of the RFID chip of the at least one RFID tag. The acoustic sensor, the RFID chip and the microcontroller are arranged such that the microcontroller modifies the state of the registry of the RFID chip when the acoustic sensor receives a signal of frequency f1−f2, the state of the registry being contained in the response signal from the at least one tag.

According to another embodiment, the RFID tag is an active or semi-passive tag including an RFID chip coupled to a magnetic antenna and the acoustic sensor is a resistive sensor powered by the tag. The resistance varies according to the frequency of the acoustic signal captured such that the acoustic sensor has a first resistance value when the acoustic signal captured has a frequency f1−f2 and a second resistance value when the acoustic signal captured has a frequency f1 or f2. The acoustic sensor and the RFID chip are arranged such that the RFID chip writes in one of its registries a state representative of the value of the resistance of the acoustic sensor, the state of the registry being contained in the response signal from the at least one tag.

According to a specific embodiment, the acoustic sensor is a sensor printed on a substrate of the tag.

According to a specific embodiment, the system further includes a control circuit coupled to the RFID reader, the control circuit being able to move the position of the at least one ultrasound generator in order to move the zone of sound. The RFID reader can therefore locate, zone-by-zone, the RFID tags present in the predetermined space.

Advantageously, the system includes a plurality of ultrasound generators positioned in the predetermined space or near to the predetermined space in order to scan all of the predetermined space with the signals of frequency f1−f2.

According to a specific embodiment, each ultrasound generator includes a plurality of basic ultrasound sources distributed on a disc of diameter D.

According to one advantageous embodiment, the ratio D/λ is greater than 4.7, where λ is the wavelength of the signal of frequency f1 or f2.

According to a specific embodiment, the frequencies f1 and f2 are between 40 kHz and 200 kHz, preferably between 40 kHz and 100 kHz in order to limit the reduction in signal strength and thus increase the zone of sound created. According to a specific embodiment, the frequency f1−f2 is between 15 kHz and 20 kHz, preferably between 18 kHz and 20 kHz so as not to be audible to the human ear.

According to a specific embodiment, the ultrasound signals of frequency f1 and f2 are emitted over one or more time periods with a duration of less than 15 ms. Below this duration, the human ear does not perceive the presence of a sound signal.

These and other advantages will become apparent to those of ordinary skill in the art upon reading the following examples, illustrated by the accompanying figures, provided for the purposes of illustration only.

### BRIEF DESCRIPTION OF THE FIGURES

FIG. 1 shows the phenomenon of generating a parametric wave from ultrasonic waves;

FIG. 2 shows the appearance of the parametric wave in the far field;

FIG. 3 is a diagram of a system according to some embodiments;

FIG. 4 is an image of an ultrasound generator of the system in FIG. 3;

FIG. 5 is a diagram of an RFID tag equipped with an acoustic sensor according to a first embodiment of some embodiments;

FIG. 6 shows two curves illustrating the operation of the tag in FIG. 5;

FIG. 7 is a diagram of an RFID tag equipped with an acoustic sensor according to a second embodiment of some embodiments; and

FIG. 8 is a diagram of an RFID tag equipped with an acoustic sensor according to some embodiments.

### DETAILED DESCRIPTION OF THE EMBODIMENTS

According to some embodiments, RFID technology is combined with parametric wave technology to locate RFID tags. The parametric wave phenomenon is based on the non-linear effects of the propagation of acoustic waves. This phenomenon was described for the first time by Westervelt. It was then used in several fields, in particular for the manufacture of directional speakers.

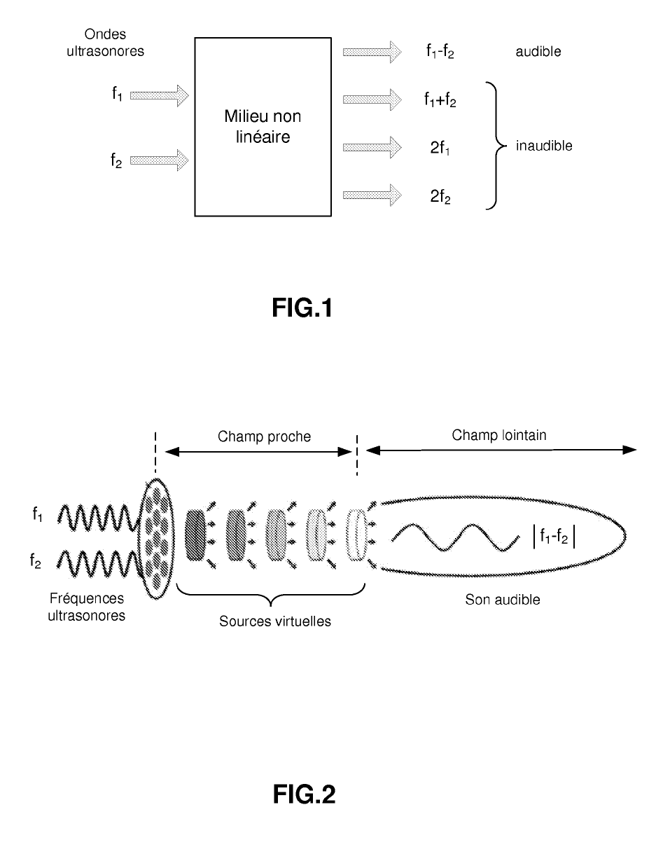

This phenomenon was described by Westervelt as follows: “if two acoustic plane waves of different frequency propagate along coincident paths, new waves are generated. The frequency of one of the new waves is equal to the sum of the two primary frequencies and the other has a frequency equal to the difference between the two primary frequencies” FIG. 1 shows the generation of waves of frequency f₁−f₂, f₁+f₂, 2f₁ and 2f₂ through a non-linear environment (air) from ultrasonic waves of frequency f₁ and f₂, where f₁>f₂. The frequencies f₁ and f₂ are greater than 20 kHz. Only the frequency f₁−f₂ is audible to the human ear if it is low enough (less than 15 kHz). The wave of frequency f1−f2 only appears in the far field, i.e. beyond the Rayleigh length as shown in FIG. 2. The advantage of the parametric wave of frequency f1−f2 generated is that it is very directive, especially if the emission surface of the ultrasound source is extended relative to the wavelength of the ultrasonic waves. This will be described in detail hereinbelow.

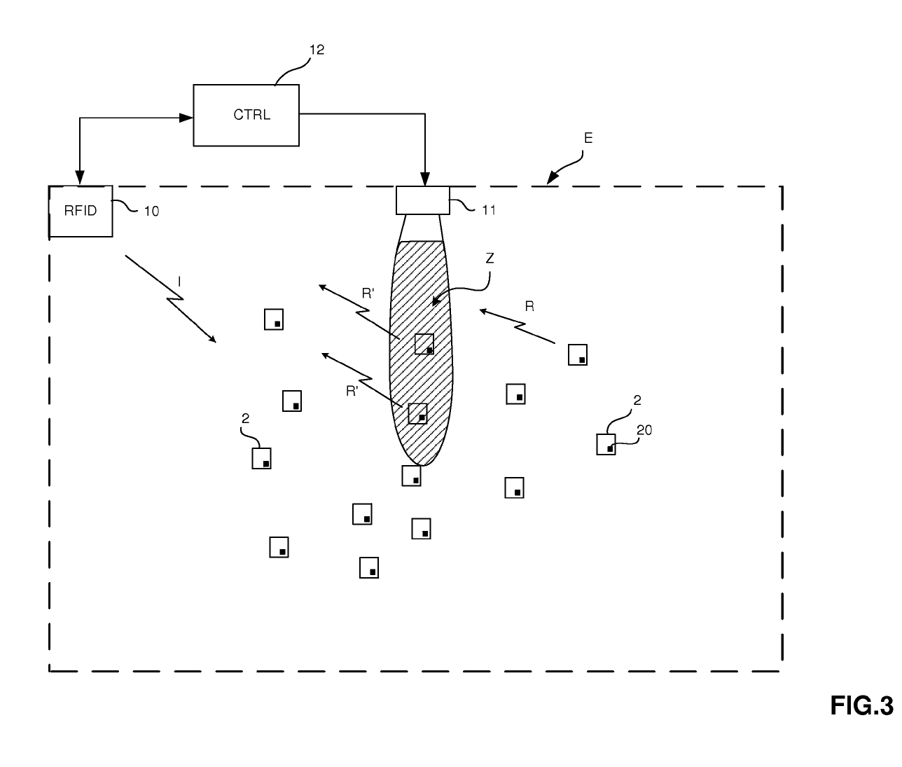

Some embodiments can use this directivity feature to locate RFID tags. FIG. 3 shows, in a diagrammatic manner, a system according to some embodiments.

With reference to FIG. 3, the system includes an RFID reader 10, a plurality of RFID tags 20 arranged on objects 2 to be located, an ultrasound generator 11 and a control circuit 12. The objects 2 are present in a predetermined space E. The RFID tags 20 are active, passive or semi-passive tags.

The RFID reader 10 is capable of emitting a radiofrequency interrogation signal I to the RFID tags 20 present in the space E and of receiving response signals R and R′ originating from the tags.

The ultrasound generator 11 is used to generate the ultrasound signals of frequency f₁ and f₂ greater than 20 kHz and a parametric signal of frequency f₁−f₂ in the far field in a specific zone, called a zone of sound Z (hatched zone in FIG. 3), of the space E. The frequency f₁−f₂ is less than 20 kHz. The zone Z extends beyond the near field limit of the ultrasound generator 11. The characteristics of this zone depend on the ultrasound generator 11.

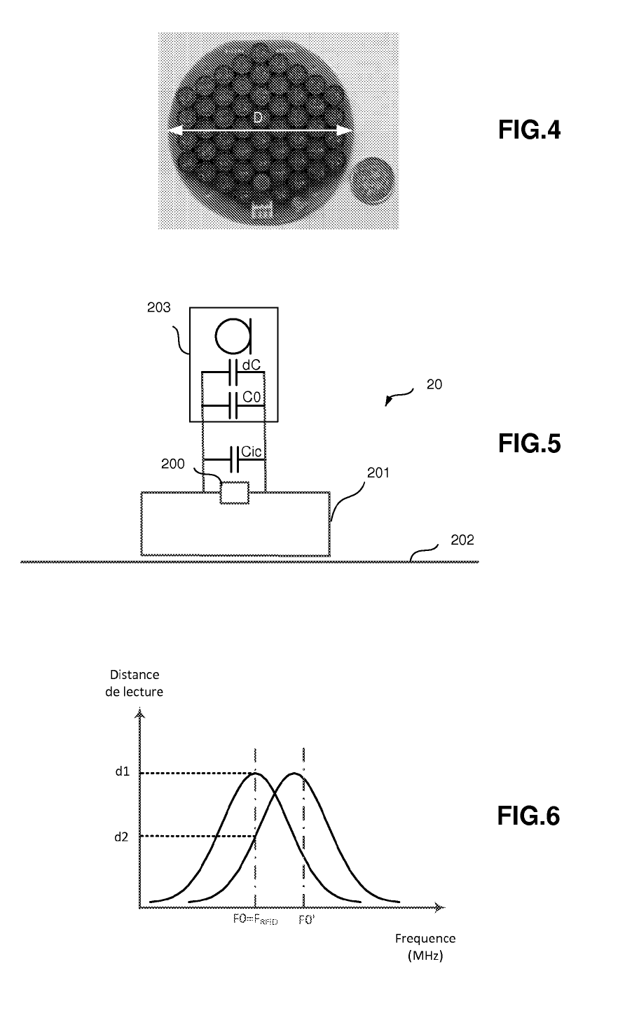

The ultrasound generator 11 is a parametric emitter emitting ultrasonic waves having high directivity. The ultrasonic waves of frequencies f₁ and f₂ are emitted in a given direction to generate in the far field a sound signal in a limited zone of the space E. This emitter is, for example, the AS050A emitter marketed by the Japanese firm NICERA. This emitter is made from a plurality of piezoelectric transducers arranged in relation to each other so as to form a disc having a diameter D. The AS050A emitter includes 50 transducers operating in the 40 kHz band and has a diameter D=4 cm. A photo of this emitter is shown in FIG. 4.

As can be seen in the following table, the larger the diameter of this ultrasonic source, the further away the near field limit, and the greater the directivity of the sound wave. In this table, these values have been obtained for frequencies f1 and f2 respectively equal to 41 kHz and 40 kHz.

| | | Directivity at the |
|---|---|---|
| | Near field | near field limit |
| D/λ | limit (cm) | (degrees) |
| 4.7 | 4.8 | 15 |
| 8 | 13 | 11 |
| 13 | 35 | 6 |
| 20 | 80 | 4 |

Moreover, the larger the diameter of this ultrasonic source, the greater the maximum pressure level of the sound wave (in dB SPL).

The sound wave produced by the ultrasound generator is intended to be captured by an acoustic sensor.

For this purpose, each tag 20 is equipped with an acoustic sensor capable of capturing signals of frequency f₁−f₂. This acoustic sensor is coupled to the tag so as to modify or reduce the strength of the response signal from the RFID tag when the latter receives the interrogation signal I originating from the RFID reader 10. The tags present in the zone Z therefore return a response signal R′ that is modified relative to the other tags, which return a response signal R. The RFID reader 10 can therefore identify, via the response signals R′, the tags present in the zone Z and can thus locate the objects 2 present in the zone.

FIG. 5 illustrates the case of a passive tag 20 equipped with a capacitive acoustic sensor 203 for implementing some embodiments. The tag 20 includes, in a conventional manner, an RFID chip 200, a magnetic antenna 201, and an electric antenna 202 of the dipole type, coupled to the magnetic antenna. The capacitive acoustic sensor is connected in parallel with the loop of the magnetic antenna. It is intended to modify the resonant frequency of the tag when it receives a sound signal of frequency f1−f2.

The resonant frequency specific to the tag thus varies under the effect of the acoustic wave of f1−f2. For example, the magnetic loop of the tag is considered to have an inductance L0 and a capacitance C0 in the absence of acoustic pressure on the sensor. The RFID chip has a capacitance Cic. In the absence of acoustic pressure on the sensor, the resonant frequency F0 of the tag is given by the following formula:

F0=1/(2π·\sqrt{L0·Cic·C0})

When the acoustic pressure moves the membrane of the capacitive sensor enough to reduce the distance between its two armatures, this pressure varies the capacitance of the magnetic loop by a value dC. The resonant frequency of the tag is therefore reduced and equal to

F0′=1/(2π·\sqrt{L0·Cic·(C0+dC)})

As shown in FIG. 6, the frequency F0′ is no longer set to the frequency F_{RFID} of the interrogation signals and response signals. This offset of the resonant frequency of the magnetic loop of the tag therefore results in a reduction in the strength of the response signal returned by the tag. This reduction in the strength of the response signal is represented by a reduction of the tag reading distance, which changes from d1 to d2.

If the reduction is significant, the strength of the response signal R′ may not be enough to be received by the RFID reader.

In this embodiment, the receipt of the parametric signal by the acoustic sensor therefore enables the frequency to be offset by the maximum amplitude of the response signal of the tag, and thus the reduction of the strength of the response signal of the tag.

This slow and weak variation of amplitude in time can be detected by the RFID reader in the baseband of its receiving circuit. Indeed, the amplitude modulation of the retro-modulated digital RFID signal varies at frequencies between a minimum of 20 kHz to 40 kHz and a maximum of 640 kHz depending on the chosen throughput for the UHF Gen2 RFID standard communication protocol. If the additional amplitude variation caused by the acoustic pressure is between 3 and 18 kHz, it can be easily separated from the digital communication signals received from the RFID tag by a low-pass filter. At the output of this filter, only the acoustic amplitude modulation will be available and a digital or analogue tone detector set to the acoustic frequency emitted by the reader will therefore be able to correlate a digital RFID response from a tag to its presence in an acoustic field.

The acoustic sensor 203 can be produced by printing on the flexible substrate of the tag 20 itself.

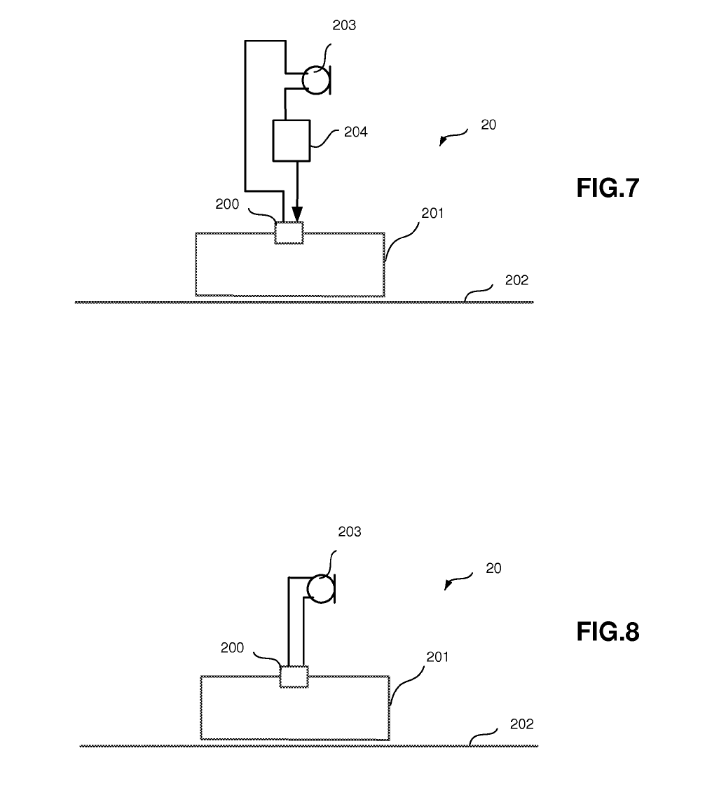

According to another embodiment illustrated by FIG. 7, the acoustic sensor is a piezoelectric sensor, for example of MEMS type. These sensors are traditionally used as microphones in mobile phones due to their very low bulk. The RFID tag is a semi-passive tag (BAP), equipped, for example, with the RFID chip EM4325 by the firm MeMarin. It has an output enabling it to power the acoustic sensor 203 as well as a microcontroller 204. In this embodiment, if the frequency of the acoustic signal received by the acoustic sensor 203 is equal to f1−f2, the microcontroller 204 writes an information item representative of this receipt in a registry of the chip 200. This registry is read when the tag receives the interrogation signal from the RFID reader. An information item representative of the state of this registry is transmitted to the RFID reader via the response signal.

There are other possibilities: the identifier ePC of the RFID TAG can be modified depending on whether a sound is detected by the tag. The microcontroller can also switch off or wake up the circuit of the tag via a digital command.

In order to detect the receipt of the frequency f1−f2 by the acoustic sensor 203, the microcontroller 204 can implement a DFT (Discrete Fourier Transform), for example by implementing a Goertzel algorithm. This algorithm is used for the detection of audible DTMF (Dual Tone Multi Frequency) signals used to encode the keys of a handset in conventional telephony. The simple structure of the Goertzel algorithm allows for its easy implementation in a small microcontroller requiring a minimum number of operations, and thus consuming as little power as possible. Additional simplification is possible by selecting a sampling frequency of the analogue-to-digital conversion circuit of the microcontroller that is four times greater than that of the signal sought. In this specific case, the operations to be performed are even simpler: they are reduced to additions and subtractions. A 16-bit microcontroller implementing fixed-point operations is sufficient for detecting the frequency as long as it is accurately known to the nearest 100 Hz. This therefore overcomes unwanted background noise.

According to another embodiment illustrated in FIG. 8, acoustic sensors can also be used, the impedance (resistance) of which varies with the frequency of the signal received. The acoustic sensor is powered by the tag, which can be passive, active or semi-passive. The acoustic sensor is connected between an input and an output of the RFID chip of the tag. This RFID chip is, for example, the G2iL+ chip by the firm NXP. On each powering on of the RFID chip, i.e. as soon as it is remotely powered by a UHF radiofrequency field, the latter briefly injects a current into the acoustic sensor for a few microseconds. The acoustic sensor is, for example, designed such that its impedance is greater than 20 MOhms when it does not receive any sound signal at the frequency f1−f2 and such that it is less than 2 MOhms when it receives such a sound signal.

If the impedance of the acoustic sensor is greater than 20 MOhms, the voltage across its terminals is high enough to allow the RFID chip to detect an open circuit. Conversely, if the impedance is less than 2 MOhms, the voltage across the terminals of the acoustic sensor is less than a predetermined voltage threshold and the RFID chip detects a low impedance or a short circuit. Each of these two states corresponds to a different high or low binary value recorded in a registry of the memory of the chip. This registry is read when the tag receives the interrogation signal from the RFID reader. An information item representative of the state of this registry is transmitted to the RFID reader via the response signal.

Such an acoustic pressure sensor having an impedance that varies according to the sound levels can be considered for manufacture by a printed method. A low-pass filter is advantageously added in order to integrate and smooth out the low-frequency variations in the acoustic pressure detected. Alternatively, a mechanical hysteresis is integrated into the sensor, the mechanical hysteresis maintaining the resistance at a stable value between two alternations of the low-frequency acoustic wave. This natural remanence enables the integrated circuit to measure a stable impedance at the scale of the few hundred microseconds required for the impedance measurement.

With reference again to FIG. 3, all of the tags 20 present in the zone of sound Z therefore return a modified response signal R′. The content or strength of this response signal R′ is modified. The tags can therefore be identified by the RFID reader 10 as being present in the zone of sound Z.

In order to locate the other tags present in the space E, the space E must be scanned zone by zone. For this purpose, the control circuit 12 (FIG. 3) moves the ultrasound generator 11 in a horizontal or vertical plane. It can also angularly displace it (rotation about a vertical or horizontal axis). The latter can be positioned in the centre of the space E or on one of its sides (as shown in FIG. 3). The same applies for the RFID reader 10.

A plurality of fixed or mobile ultrasound generators can also be provided in order to better cover the space E.

The principle of some embodiments has been tested with different frequency values f1 and f2, in particular f₁=41 kHz and f₂=39 kHz, in addition to f1=81 kHz and f2=78 kHz. The frequencies f1 and f2 are preferably between 40 kHz and 100 kHz in order to limit the reduction in signal strength and thus increase the zone of sound created.

The sound signal of frequency f1−f2 is audible if f1−f2<18 kHz. In such a case, the ultrasound signals f1 and f2 are preferably emitted periodically for a duration not exceeding 15 ms, below which the resulting sound signal is not perceived by the human ear. Ultrasound signals are, for example, emitted every 2 seconds for a duration of 15 ms.

According to another embodiment, ultrasound signals are used, such that the difference f1−f2 is between 18 kHz and 20 kHz. The parametric signal is not audible, however remains directive.

The embodiments described hereinabove were provided for the purposes of illustration only. It is clear for one of ordinary skill in the art that they can be modified, in particular with regard to the type of acoustic sensor or ultrasound generator used.

1. A system for locating at least one object in a predetermined space, the system comprising:
at least one RFID tag positioned in or on an object to be located in the predetermined space;
an RFID reader capable of emitting at least one radiofrequency interrogation signal to the RFID tag and of receiving a radiofrequency response signal from the RFID tag;
at least one ultrasound generator capable of emitting in a given direction ultrasound signals of frequencies f1 and f2 in the predetermined space, where f1>f2, so as to generate a directive parametric signal of frequency f1−f2 in a specific zone, called a zone of sound, of the predetermined space, the so-called inaudible frequencies f1 and f2 being greater than 20 kHz and the so-called audible frequency difference f1−f2 being less than 20 kHz,
wherein the at least one tag is further equipped with an acoustic sensor able to capture the signals of frequency f1−f2, the acoustic sensor being designed together with the RFID tag to modify the content or the level of the RFID tag response signal when the acoustic sensor receives a signal of frequency f1−f2, the RFID reader being thus able to locate the object in said zone of sound when it receives the modified response signal from the RFID tag.

2. The system according to claim 1, wherein the at least one RFID tag is a passive tag comprising an RFID chip coupled to a magnetic antenna, and the acoustic sensor is a capacitive sensor coupled to the magnetic antenna so as to modify the resonant frequency of the magnetic antenna when the acoustic sensor receives a signal of frequency f1−f2.

3. The system according to claim 1, wherein the at least one RFID tag is an active or semi-passive tag comprising an RFID chip coupled to a magnetic antenna, and the acoustic sensor is a piezoelectric sensor powered by the at least one RFID tag and in that said the at least one RFID tag is equipped with a microcontroller powered by the at least one RFID tag and capable of writing in a registry of the RFID chip of said at least one RFID tag, the acoustic sensor, the RFID chip and the microcontroller being arranged such that the microcontroller modifies the state of the registry of the RFID chip when the acoustic sensor receives a signal of frequency f1−f2, the state of the registry being contained in the response signal from said at least one tag.

4. The system according to claim 1, wherein the at least one RFID tag is an active or semi-passive tag comprising an RFID chip coupled to a magnetic antenna, and the acoustic sensor is a resistive sensor powered by the tag and the resistance of which varies according to the frequency of the acoustic signal captured, the acoustic sensor having a first resistance value when the acoustic signal captured has a frequency f1−f2 and a second resistance value when the acoustic signal captured has a frequency f1 or f2, the acoustic sensor and the RFID chip being arranged so that the RFID chip writes in a registry a state representative of the value of the resistance of the acoustic sensor, the state of the registry being contained in the response signal from the at least one tag.

5. The system according to claim 1, wherein the acoustic sensor is a sensor printed on a substrate of the tag.

6. The system according to claim 1, further comprising a control circuit coupled to said RFID reader, the control circuit being able to move the position of the at least one ultrasound generator in order to move the zone of sound.

7. The system according to claim 1, further comprising a plurality of ultrasound generators positioned in the predetermined space or near to the predetermined space in order to scan all of the predetermined space with the signals of frequency f1−f2.

8. The system according to claim 1, wherein each ultrasound generator includes a plurality of basic ultrasound sources distributed on a disc of diameter D.

9. The system according to claim 8, wherein the ratio D/λ is greater than 4.7, where λ is the wavelength of the signal of frequency f1 or f2.

10. The system according to claim 1, wherein the frequencies f1 and f2 are between 40 kHz and 200 kHz.

11. The system according to claim 1, wherein the frequency f1−f2 is between 15 kHz and 20 kHz.

12. The system according to claim 1, wherein the ultrasound signals of frequency f1 and f2 are emitted over one or more time periods with a duration of less than 15 ms.

13. The system according to claim 11, wherein the frequency f1 and f2 is between 18 kHz and 20 kHz.
